(19) United States
(12) Patent Application Publication
(10) Pub. No.: US 2002/0197016 A1
(43) Pub. Date: Dec. 26, 2002

(54) Photodetector having a waveguide and resonant coupler and a method of manufacture therefor

(76) Inventors: Sethumadhavan Chandrasekhar, Matawan, NJ (US); Andrew G. Dentai, Atlantic Highlands, NJ (US); Barry F. Levine, Livingston, NJ (US); Thomas G.B. Mason, Bethlehem, PA (US); Ola Sjolund, Macungie, PA (US)

Correspondence Address: HITT GAINES & BOISBRUN P.C., P.O. BOX 832570, RICHARDSON, TX, 75083, US

(21) Appl. No.: 09/885,638

(22) Filed: Jun. 20, 2001

(51) Int. Cl. G02B 6/26

(52) U.S. Cl. 385/50; 385/39

(57) ABSTRACT

A photodetector and a method of manufacture therefor. The photodetector includes a waveguide located over a photodetector substrate and a resonant coupler located over and coupled to the waveguide. An index of refraction of the resonant coupler is greater than an index of refraction of the waveguide. The photodetector also includes an absorber located over and coupled to the resonant coupler, wherein the absorber has an index of refraction greater than the index of refraction of the resonant coupler.

### TECHNICAL FIELD OF THE INVENTION

The present invention is directed, in general, to an optoelectronic device and, more specifically, to a photodetector having a waveguide and resonant coupler, and a method of manufacture therefor.

### BACKGROUND OF THE INVENTION

PIN photodetectors are currently widely used in long-wavelength (e.g., 1.3 μm to about 1.55 μm) optical receivers for telecommunications systems. Turning to Prior Art FIG. 1, illustrated is a conventional face-receptive PIN photodetector 100. The face-receptive PIN photodetector 100 includes an optical substrate 110 having an undoped indium phosphide (InP) buffer layer 120 located thereon. The face-receptive PIN photodetector 100 further includes an undoped absorber layer 130 located on the undoped buffer layer 120, and an undoped Q-cap layer 140 located on the undoped absorber layer 130. Located within the undoped Q-cap layer 140 and contacting the undoped absorber layer 130 is a P++ diffusion region 150.

As can be assumed, a p-n junction is created by the formation of the P++ diffusion region 150 through the undoped Q-cap layer 140, and down into the undoped absorber layer 130. When a reverse-bias voltage, as is commonly used, is applied to the face-receptive PIN photodetector 100, an electric field exists across the undoped absorber layer 130. Photogenerated charge carriers, e.g., electrons or holes, may then move under the influence of this electric field. As a result, an electric current flows, converting optical radiation 160 into an electrical signal.

Face-receptive PIN photodetectors 100 are well-known and commonly used, however, they experience certain drawbacks. One of such drawbacks is that the face-receptive PIN photodetector 100 generally requires a mirror to direct the optical radiation from an in-plane waveguide to the face-receptive PIN photodetector 100. Fabrication of the mirror tends to be difficult and time consuming, and can add considerable cost to the light guide circuit. Another drawback is that the optical efficiency of the face-receptive PIN photodetector 100 is fundamentally limited by the thin undoped absorber layer 130, which must be used to obtain a high transit time limited bandwidth.

In an effort to correct many of the problems associated with the use of the face-receptive PIN photodetector 100, the optoelectronic industry has experimented with edge illuminated PIN photodetectors. Turning to Prior Art FIG. 2, illustrated is one example of an edge illuminated PIN photodetector 200. As illustrated, optical radiation 210 encounter the edge illuminated PIN photodetector 200 from an edge, rather than a face, as illustrated in Prior Art FIG. 1. Because the optical radiation 210 enter the edge illuminated PIN photodetector 200 from the edge, the decreasing thicknesses of the undoped absorber layer 130 does not substantially affect the edge illuminated PIN photodetector's 200 performance, as compared to the face-receptive PIN photodetector 100. As a result, PIN based photodetectors, having bandwidths up to about 110 GHz, are achievable.

While the edge illuminated PIN photodetector 200 achieves very high speeds, they also experience certain drawbacks. One of such drawbacks is the difficulty in efficiently coupling optical radiation 210 from an optical fiber to the edge illuminated PIN photodetector 200. This is generally a result of the small mode size used in the edge illuminated PIN photodetector 200. Another drawback is that the length of the edge illuminated PIN photodetector 200 must typically be very short, on the order of about 20 μm, which is difficult to fabricate as a conventional structure.

Two known attempts have been made to correct the drawbacks associated with the edge illuminated PIN photodetector 200, while still achieving its benefits. One such attempt is to make the edge illuminated PIN photodetector's 200 waveguide large enough to support multiple optical modes. This enables higher coupling efficiency, however, does not solve the fabrication issue for the short detector lengths. Another attempt is to use an evanescently coupled edge illuminated PIN photodetector. In this attempt, light is first coupled into a passive input waveguide and then evanescently transferred into the edge illuminated PIN photodetector 200. The problem experienced by the evanescently coupled edge illuminated PIN photodetector is that these devices typically only have about a 25% coupling efficiency.

Accordingly, what is needed in the art is an edge illuminated PIN photodetector that may be easily coupled to optical radiation emitted from an optical fiber, however, one that does not experience the drawbacks experienced by the prior art.

### SUMMARY OF THE INVENTION

To address the above-discussed deficiencies of the prior art, the present invention provides a photodetector, a method of manufacture therefor, and an optical fiber communications system including the photodetector. The photodetector includes a waveguide located over a photodetector substrate and a resonant coupler located over and coupled to the waveguide. An index of refraction of the resonant coupler is greater than an index of refraction of the waveguide. The photodetector also includes an absorber layer located over and coupled to the resonant coupler, wherein the absorber layer has an index of refraction greater than the index of refraction of the resonant coupler.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

The invention is best understood from the following detailed description when read with the accompanying FIGURES. It is emphasized that in accordance with the standard practice in the optoelectronic industry, various features may not be drawn to scale. In fact, the dimensions of the various features may be arbitrarily increased or reduced for clarity of discussion. Reference is now made to the following descriptions taken in conjunction with the accompanying drawings, in which:

Prior Art FIG. 1 illustrates a conventional face-receptive PIN photodetector;

Prior Art FIG. 2 illustrates an edge illuminated PIN photodetector;

FIGS. 3A and 3B illustrate various cross-sectional views of a completed photodetector, which is in accordance with the teachings of the present invention;

FIG. 4 illustrates a cross-sectional view of a partially completed photodetector;

FIG. 5 illustrates a graph illustrating one embodiment of attainable far field divergence angles;

FIGS. 6A and 6B illustrate the partially completed photodetector illustrated in FIG. 4, after formation of a first photodetector contact;

FIGS. 7A and 7B illustrate the partially completed photodetector illustrated in FIGS. 6A and 6B, after defining an absorber;

FIGS. 8A and 8B illustrate the partially completed photodetector illustrated in FIGS. 7A and 7B, after formation of second photodetector contacts;

FIGS. 9A and 9B illustrate the partially completed photodetector illustrated in FIGS. 8A and 8B, after etching the second cladding layer;

FIGS. 10A, 10B and 10C illustrate the partially completed photodetector shown in FIGS. 9A and 9B, after defining a resonant coupler;

FIGS. 11A and 11B illustrate the partially completed photodetector illustrated in FIGS. 10A, 10B and 10C, after an etching process;

FIGS. 12A and 12B illustrate the partially completed photodetector illustrated in FIGS. 11A and 11B, after formation of a layer of passivation material thereover;

FIGS. 13A and 13B illustrate the partially completed photodetector illustrated in FIGS. 12A and 12B, after formation of contact openings;

FIGS. 14A and 14B illustrate the partially completed photodetector illustrated in FIGS. 13A and 13B, after formation of an interconnect metal layer;

FIG. 15 illustrates an optical fiber communication system, which may form one environment in which a completed photodetector similar to the completed photodetector illustrated in FIG. 3, may be used; and

FIG. 16 illustrates an alternative optical fiber communication system, having a repeater, including a second transmitter and a second receiver located, between the transmitter and the receiver.

### DETAILED DESCRIPTION

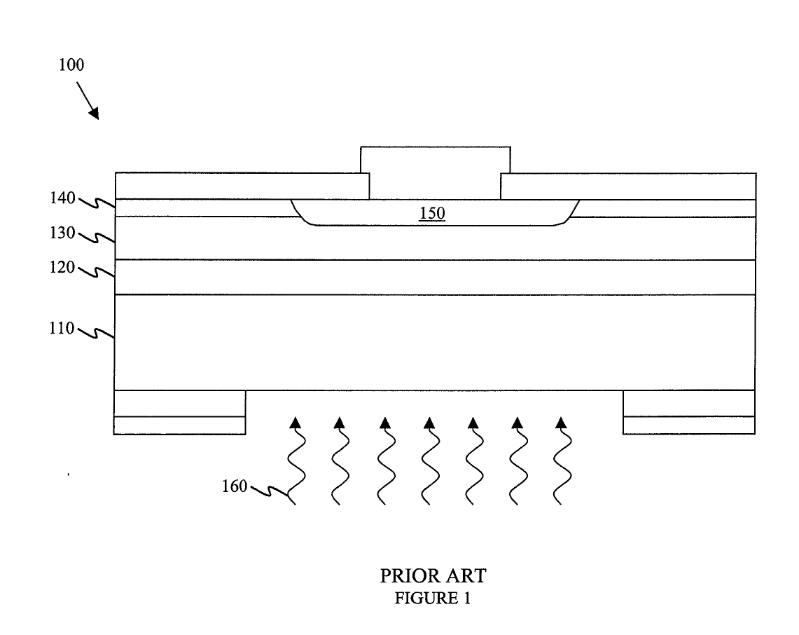

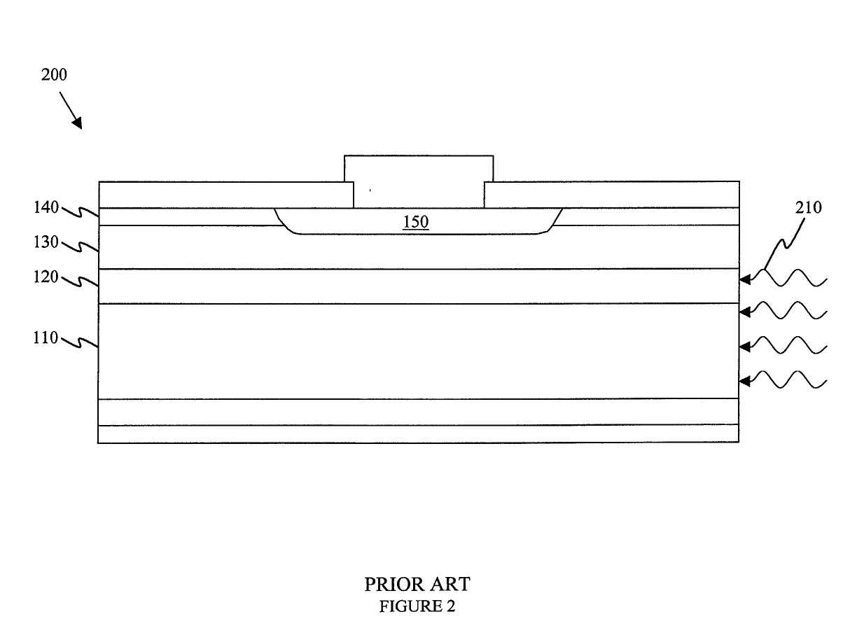

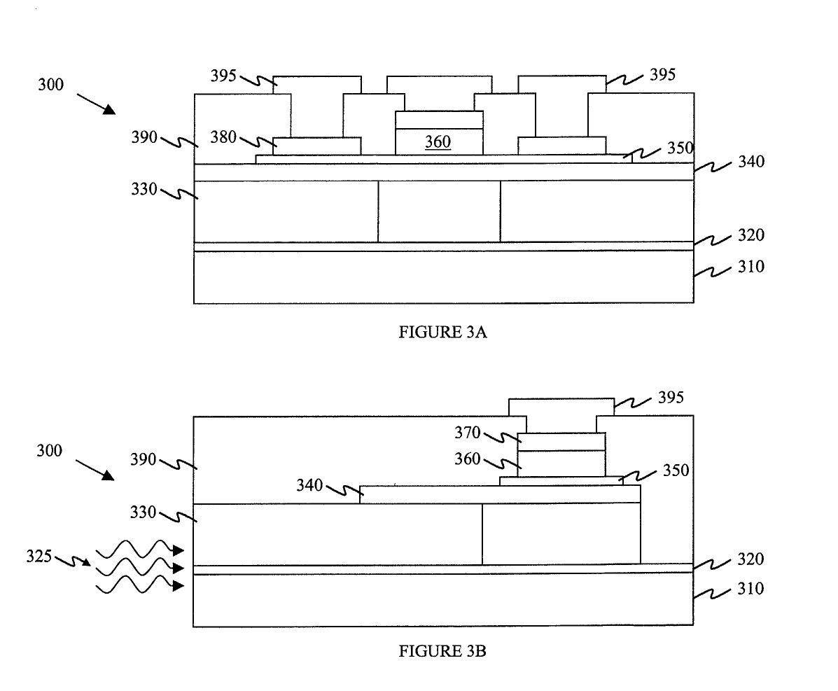

Referring initially to FIGS. 3A and 3B, illustrated are various cross-sectional views of a completed photodetector 300, which is in accordance with the teachings of the present invention. It should initially be noted that the multiple cross-sectional views are being used to better depict the present invention. It should additionally be noted that views depicted by the letter A (e.g., FIG. 3A) depict a lateral cross-section, views depicted by the letter B (e.g., FIG. 3B) depict a longitudinal cross-section, and where applicable, views depicted by the letter C illustrate a top view.

In the illustrative embodiment shown in FIGS. 3A and 3B, the photodetector 300 includes a photodetector substrate 310. Formed over the photodetector substrate 310 is a waveguide 320. The waveguide 320 provides an easy coupling point for light 325 emitted from an associated optical fiber. The light emitted from an associated optical fiber tends to have a large mode size, which may be detrimental to coupling efficiency. In an exemplary embodiment of the present invention, a first cladding layer 330 is located on the waveguide 320. The first cladding layer 330, which may be an indium phosphide (InP) cladding layer, initially keeps the light within the waveguide 320. However, it should be noted that this cladding layer is optional and may not be present in all embodiments.

Formed over and coupled to the waveguide 320 is a resonant coupler 340. The resonant coupler 340 has an index of refraction greater than an index of refraction of the waveguide 320. In embodiments where the first cladding layer 330 is disposed between the waveguide 320 and the resonant coupler 340, the resonant coupler 340 also has an index of refraction greater than an index of refraction of the first cladding layer 320. Because of the higher index of refraction, light traveling from a left to a right side of the photodetector 300, is pulled from the waveguide 320 up into the resonant coupler 340.

Located on the resonant coupler 340 may be a second optional cladding layer 350, such as a spacer layer. The second cladding layer 350 initially maintains the light within the resonant coupler 340. Formed over and coupled to the resonant coupler 340, and in the illustrative embodiment on the second cladding layer 350, is an absorber 360. The absorber 360 has an index of refraction greater than the index of refraction of the resonant coupler 340. Similar to above, because of the higher index of refraction, light traveling from a left to a right side of the photodetector 300, is pulled from the resonant coupler 340 up into the absorber 360, wherein it is absorbed and converted into an electrical signal.

The photodetector 300 further includes a first photodetector contact 370 formed over the absorber 360, and second photodetector contacts 380 located adjacent the absorber 360. The photodetector contacts 370, 380, in one aspect, help generate an electric field across the absorber 360. Because the first photodetector contact 370 is located in close proximity to the absorber 360, any associated P-type resistance may be reduced. Located over the surface of the photodetector 300 is a layer of passivation material 390. The layer of passivation material 390, which may be a spin-on dielectric such as biscyclobenzobutene, which is commercially available from Dow Chemical, whose business address is 2030 Dow Center, Midland, Mich. 48674, and may be known by product name cyclotene, isolates the photodetector from other devices. In the illustrative embodiment, located within openings in the layer of passivation material 390 are interconnects 395, which provide electrical contact to the photodetector contacts 370, 380.

There are a number of advantages inherent in the photodetector's 300 design that make it highly desirable for applications where bandwidths greater than about 10 GHz, and high responsivity, are desired. Using the waveguide 320 in conjunction with the resonant coupler 340 provides improved fiber coupling efficiency (e.g., up to about 90%) and increased alignment tolerances. This is because the waveguide 320 transforms the optical mode from a weakly confined input waveguide to the strongly confined resonant coupler 340, which allows light to be efficiently absorbed by the evanescently coupled absorber 360. The waveguide 320 also substantially eliminates the requirement for precision cleaving, since the photodetector 300 dimensions may be controlled lithographically. Additionally, the unique vertical coupler structure (e.g., the increase in index of refraction as the vertical height increases) enables the entire photodetector 300 to be realized in a single epitaxial growth step, if so desired. In such applications the yield is improved and the production costs are reduced. Because of the aforementioned benefits of the present invention, inexpensive photodetectors operating at 40 Gb/s and above, are achievable.

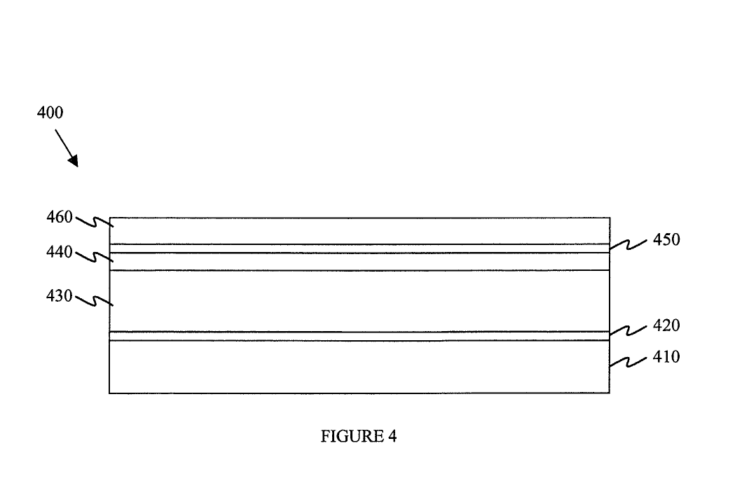

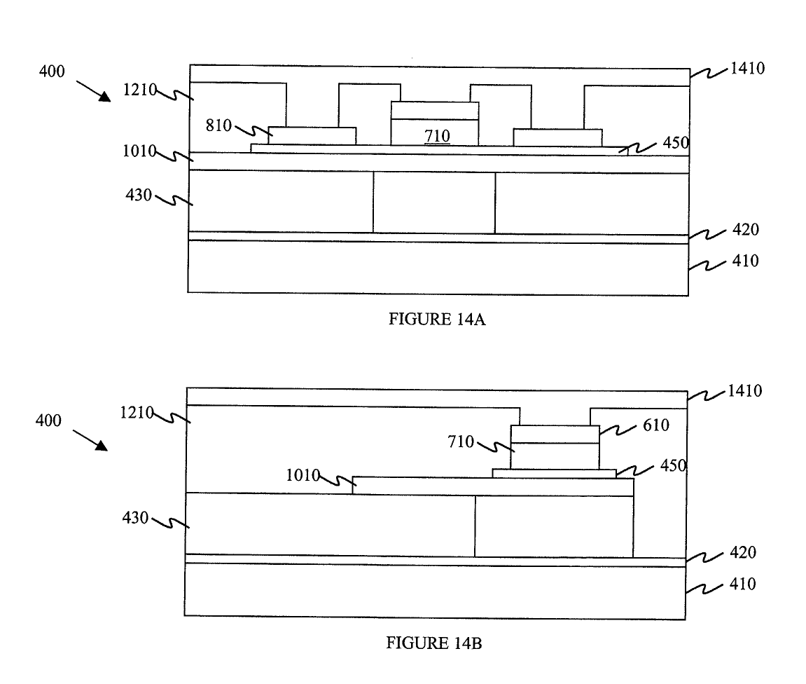

Turning to FIGS. 4-14B, illustrated are detailed manufacturing steps instructing how one might, in an exemplary embodiment, manufacture a photodetector similar to the photodetector 300 depicted in FIGS. 3A and 3B. FIG. 4 illustrates a cross-sectional view of a partially completed photodetector 400. The partially completed photodetector 400 illustrated in FIG. 4, initially includes a photodetector substrate 410 that may be formed using conventional processes. The photodetector substrate 410, which may comprise indium phosphide (InP) or another similar material, may have a wide range of thicknesses, however, in one exemplary embodiment, the photodetector substrate 410 has a thickness on the order of about 2000 nm. Additionally, the photodetector substrate 410 may be doped with iron or another similar material, if desired.

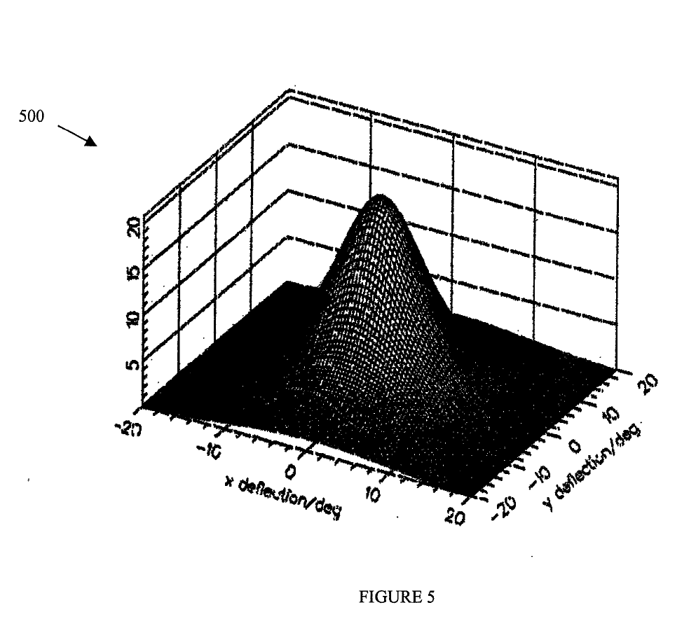

Formed over the photodetector substrate 410 is a waveguide layer 420. In an exemplary embodiment, the waveguide layer 420 comprises indium gallium arsenide phosphide (InGaAsP), however, other known or hereafter discovered waveguide layer materials are within the scope of the present invention. Again, the waveguide layer 420 may be formed using conventional deposition processes and parameters. The waveguide layer 420, which, in an advantageous embodiment, may have a bandgap (Q) of about 1.1, is formed to a thickness ranging from about 100 nm to about 200 nm, and more preferably to a thickness of about 150 nm. Additionally, the waveguide layer 420 may have an index of refraction ranging between about 3.2 and about 3.3, and more preferably, may have an index of refraction of about 3.28. It should be noted, however, that the waveguide layer 420 should have an index of refraction greater than an index of refraction of the photodetector substrate 410. The waveguide layer 420 may also have a far field divergence angle of 15 degrees or less as shown in FIG. 5, which illustrates one embodiment of attainable far field divergence angles.

Formed over the waveguide layer 420 is a first cladding layer 430. The first cladding layer 430 may comprise indium phosphide (InP) or another similar optical device material, and in certain embodiments, the first cladding layer 430 may be doped. For example, the first cladding layer 430 may be doped with an N-type dopant, such as silicon. The dopant concentration may vary and depends on performance and design specifications. Other dopant types, as well as dopant concentrations, known to those skilled in this particular are also within the scope of the present invention.

The first cladding layer 430 is generally formed to a thickness ranging from about 1500 nm to about 2500 nm, with an advantageous thickness being about 2000 nm. Additionally, the first cladding layer 430 is formed having an index of refraction less than an index of refraction of the waveguide layer 420 located thereunder. For example, in an exemplary embodiment, the first cladding layer 430 may have an index of refraction ranging from about 3.0 to about 3.2, and in a more particular aspect, it may have an index of refraction of about 3.168.

Formed over the first cladding layer 430 is a resonant coupler layer 440. The resonant coupler layer 440, which may comprise InGaAsP or another similar material, may be a doped resonant coupler layer formed with conventional deposition processes. In such embodiments, the doped resonant coupler layer 440 may be doped with an N-type dopant, such as silicon, and may further include a wide range of dopant concentrations. Such dopant concentrations may vary. For example, the dopant concentrations may range from about 5E17 atoms/cm³ to about 2E18 atoms/cm³.

The resonant coupler layer 440 may be formed to a thickness that ranges from about 200 nm to about 400 nm, with a preferred thickness being about 350 nm. Additionally, the resonant coupler layer 440 may have a bandgap of about 1.4 and an index of refraction greater than an index of refraction of the waveguide layer 420. In an exemplary embodiment, the index of refraction of the resonant coupler layer 440 ranges from about 3.3 to about 3.5, with a preferred index of refraction being about 3.45.

In certain embodiments, the waveguide layer 420 is a first waveguide layer, and the resonant coupler layer 440 is a second waveguide layer. When propagation constants are substantially the same between the waveguide layer 420 and the resonant coupler layer 440, light is more efficiently coupled from the waveguide layer 420 and into the resonant coupler 440. Thus, it is desirable, in certain embodiments, to form the device such that a propagation constant of the waveguide layer 420 or first waveguide is substantially the same as a propagation constant of the resonant coupler layer 440 or second waveguide.

Formed over the resonant coupler layer 440 is a second cladding layer 450. The second cladding layer 450, which at times may be referred to as a spacer layer, can comprise a material similar to the first cladding layer 430. For example, in one embodiment, the second cladding layer 450 comprises InP or another similar material. Additionally, the second cladding layer 450 may be a doped second cladding layer. When doped, the second cladding layer 450 may include an N-type dopant or a P-type dopant, having various concentrations. In one exemplary embodiment, the second cladding layer 450 is doped with an N-type dopant, such as silicon.

The second cladding layer 450 is desirably formed by conventional deposition processes to a thickness ranging from about 100 nm to about 200 nm, and more preferably, to a thickness of about 130 nm. Additionally, similar to the first cladding layer 430, the second cladding layer 450 may have an index of refraction ranging from about 3.0 to about 3.2, and more preferably equal about 3.168, which is less than the index of refraction of the resonant coupler layer 440.

An absorber layer 460 is formed over the second cladding layer 450. The absorber layer 460 may comprise many materials, however, in the illustrative embodiment shown in FIG. 4, the absorber layer 460 comprises InGaAs. Furthermore, the absorber layer 460 may comprise an upper doped region and a lower undoped region. In such an embodiment, the upper doped region may be doped to a dopant concentration ranging from about 5E17 atoms/cm³ to about 1E18 atoms/cm³. Likewise, the upper doped region may have a thickness of about 50 nm and the lower undoped region may comprise the remainder of a thickness of the absorber layer 460. In one example, the absorber layer 460 has a thickness of about 400 nm, wherein the upper doped region constitutes the top 50 nm and the lower undoped region constitutes the lower 350 nm.

In an exemplary embodiment, the absorber layer 460 has a bandgap of about 1.65 and may have an index of refraction greater than an index of refraction of the resonant coupler layer 440. For example, in one embodiment the absorber layer 460 has an index of refraction ranging from about 3.5 to about 3.6, and more preferably an index of refraction of about 3.56.

The above-mentioned layers, namely the waveguide layer 420, first cladding layer 430, resonant coupler layer 440, second cladding layer 450 and absorber layer 460, as mentioned above, may be formed using conventional deposition processes, such as a metal organic chemical vapor deposition (MOCVD) process. In the illustrative embodiment shown in FIG. 4, the waveguide layer 420, first cladding layer 430, resonant coupler layer 440, second cladding layer 450 and absorber layer 460 are formed using a single epitaxial deposition process. In such an embodiment, the substrate 410 is placed within a deposition chamber, and forming gasses, flow rates, temperatures, concentrations, etc., are precisely varied, resulting in the waveguide layer 420, first cladding layer 430, resonant coupler layer 440, second cladding layer 450 and absorber layer 460, respectively. While MOCVD has been discussed as one techniques used to form the waveguide layer 420, first cladding layer 430, resonant coupler layer 440, second cladding layer 450 and absorber layer 460, one skilled in the art understands that other industry standard growth techniques, such as vapor phase epitaxy and molecular beam epitaxy, may be used.

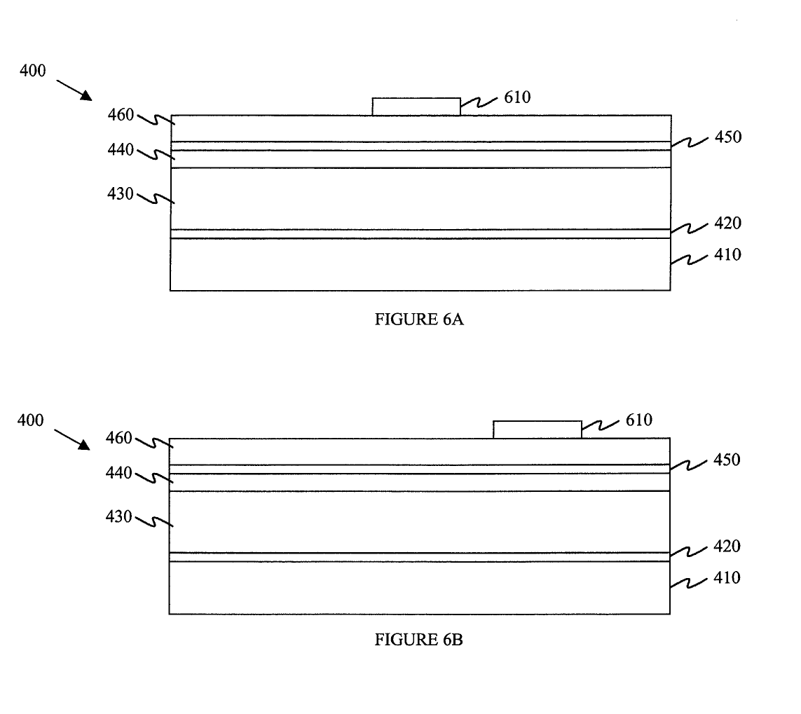

Turning to FIGS. 6A and 6B, illustrated is the partially completed photodetector 400 illustrated in FIG. 4, after formation of a first photodetector contact 610. The first photodetector contact 610, which in one embodiment may be a P metal contact, may comprise gold or another similar conductive material. The first photodetector contact 610 may have a wide range of thicknesses, however, in the illustrative embodiment shown in FIGS. 6A and 6B, the first photodetector contact 610 has a thickness of about 260 nm. Additionally, it is desired for the first photodetector contact 610 to have an associated resistance of less than about 10 ohms.

One skilled in the art understands how to form the first photodetector contact 610. In one exemplary embodiment, the first photodetector contact 610 is formed by forming photoresist portions in places where the first photodetector contact 610 is not desired, and subsequently forming metal portions where the photoresist portions are not located. After formation of the metal portions, the photoresist portions may be removed, resulting in the first photodetector contact 610. It should be noted, however, that other processes for forming the first photodetector contact 610 are also within the scope of the present invention.

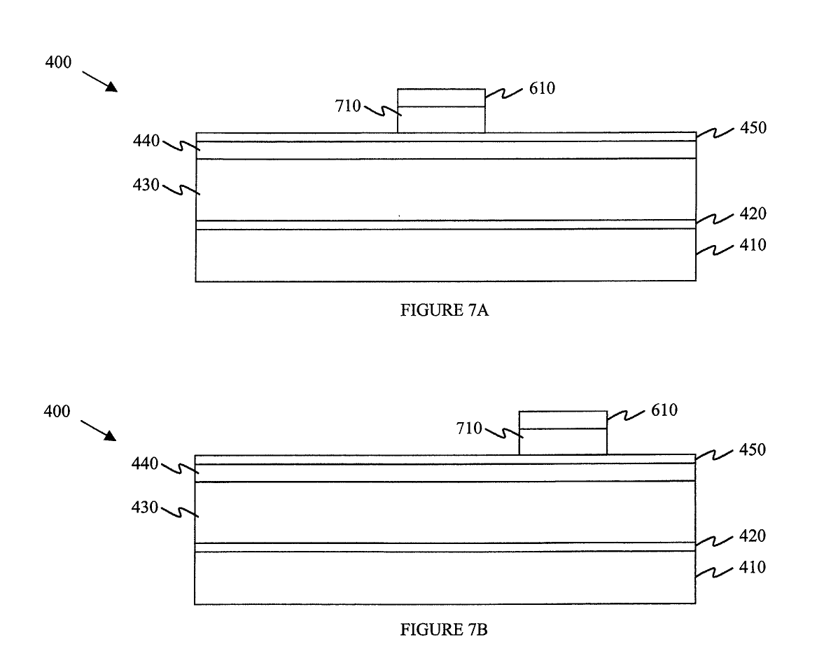

Turning to FIGS. 7A and 7B, illustrated is the partially completed photodetector 400 illustrated in FIGS. 6A and 6B, after defining an absorber 710. The absorber 710, which as previously mentioned can contain a doped upper portion and an undoped lower portion, may be defined using many processes, including the use of photoresist. However, it should be noted that in a preferred embodiment, the absorber 710 is formed by exposing the surface of the partially completed photodetector 400 shown in FIG. 6 to a citric acid etch. The citric acid etch does not substantially effect the first photodetector contact 610, and therefore, removes the portions of the absorber layer 460 (FIG. 6) unprotected by the first photodetector contact 610. One skilled in the art understands how to use the citric/hydrogen peroxide acid etch to define the absorber 710, thus, no further description is required. One skilled in the art also should realize that many other processes may be used to define the absorber 710.

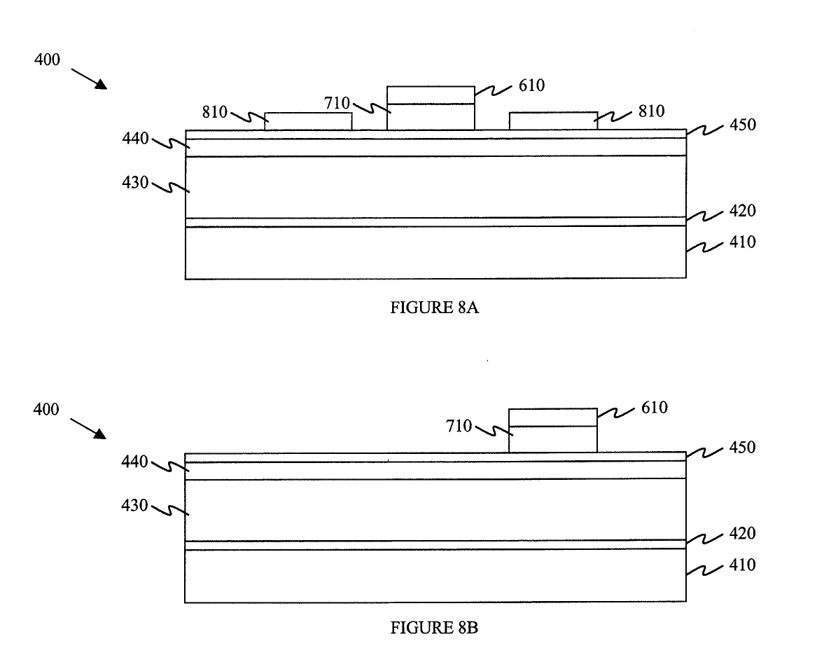

Turning to FIGS. 8A and 8B, illustrated is the partially completed photodetector 400 illustrated in FIGS. 7A and 7B, after formation of second photodetector contacts 810, which may be formed using conventional processes. The second photodetector contacts 810, which in one embodiment may be N metal contacts, may comprise gold or another similar conductive material. The second photodetector contacts 810 may have a wide range of thicknesses, however, in the illustrative embodiment shown in FIGS. 8A and 8B, the second photodetector contacts 810 have a thickness of about 260 nm. The second photodetector contacts 810, in an exemplary embodiment, have a contact resistance of less than about 1 ohm.

In one exemplary embodiment, the second photodetector contacts 810 are formed by forming photoresist portions in places where the second photodetector contacts 810 are not desired, and subsequently forming metal portions where the photoresist portions are not located. After formation of the metal portions, the photoresist portions may be removed, resulting in the second photodetector contacts 810. It should be noted, however, that other processes for forming the second photodetector contacts 810 are also within the scope of the present invention.

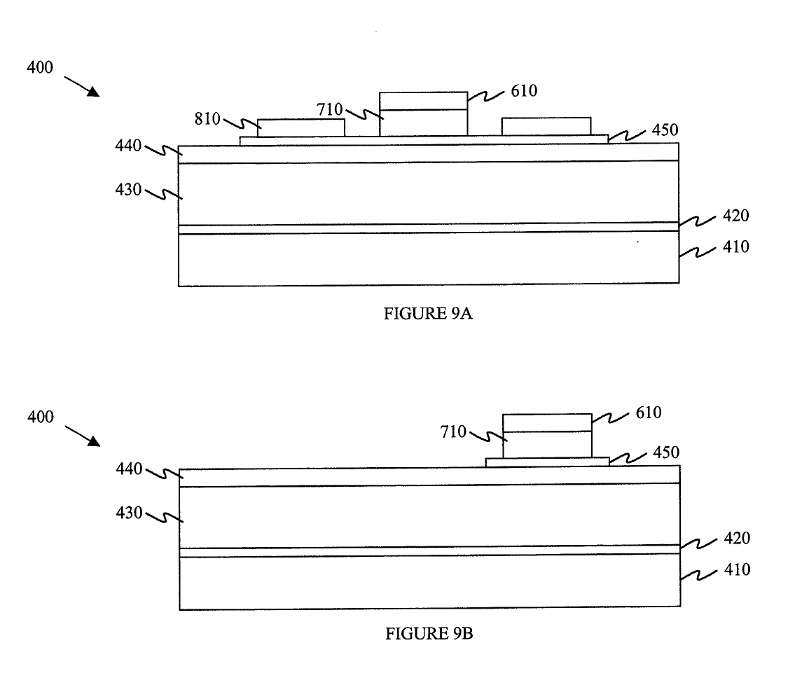

Turning to FIGS. 9A and 9B, illustrated is the partially completed photodetector 400 illustrated in FIGS. 8A and 8B, after etching the second cladding layer 450. One skilled in the art understands how to etch the second cladding layer 450. It should be noted, however, that any other known or hereafter discovered method used to etch the second cladding layer 450 is within the scope of the present invention. The second cladding layer 450 may be etched having various dimensions, however, such dimensions may vary and are specifically controlled by certain design parameters.

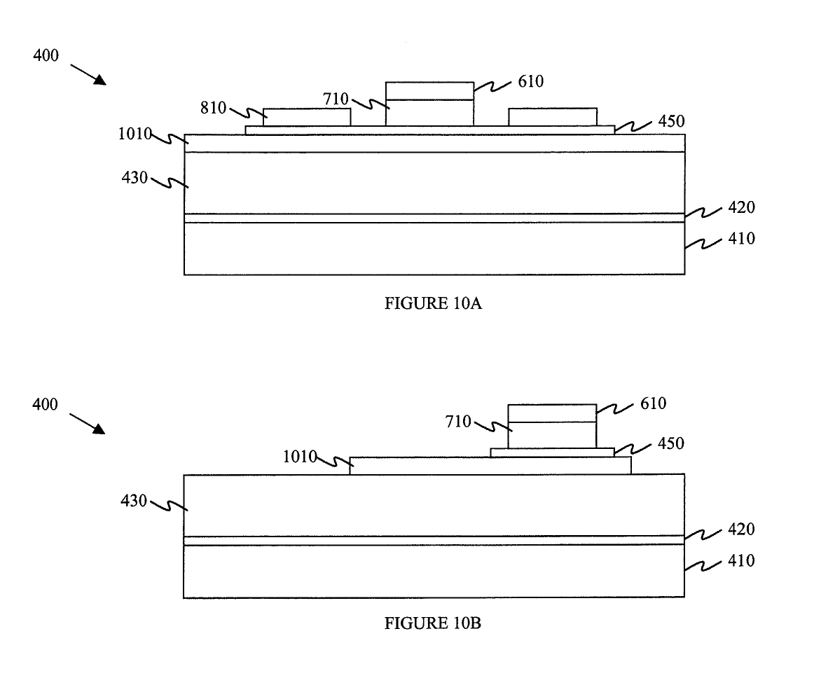

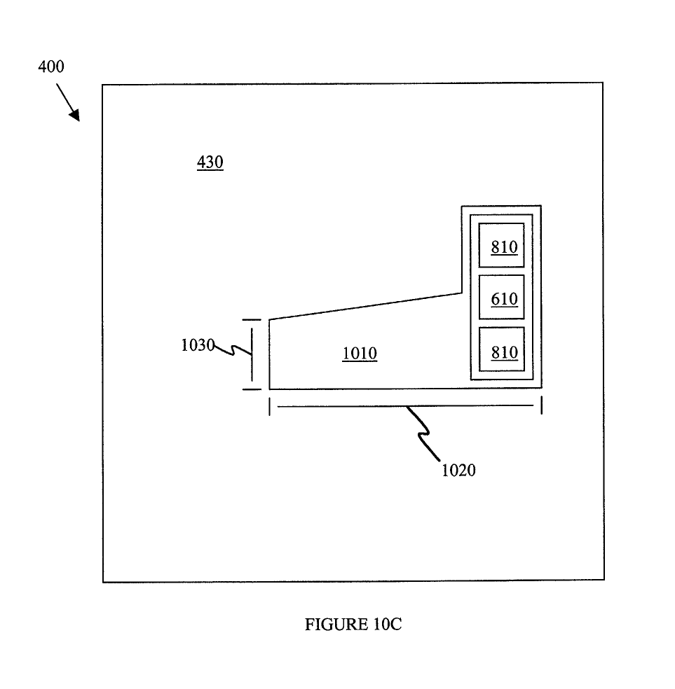

Turning to FIGS. 10A, 10B and 10C, illustrated is the partially completed photodetector 400 shown in FIGS. 9A and 9B, after defining a resonant coupler 1010. The resonant coupler 1010 may be formed using a similar process as was used in the previous step to etch the second cladding layer 450. In contrast to the dimensions of the etched second cladding layer 450, however, dimensions of the resonant coupler 1010 are preferably precisely determined and achieved. Referring to FIG. 10C, which illustrates a top view of FIGS. 10A and 10B, the partially completed photodetector has a predetermined length 1020 and width 1030. The length 1020 and width 1030 of the resonant coupler 1010 are designed to maximize the amount of light coupled to the photodetector. For example, in the illustrative embodiment the length 1020 may range from about 50 μm to about 150 μm, and the width 1030 may range from about 2 μm to about 5 μm. As also illustrated in FIG. 10C, the width 1030 of the resonant coupler 1010 may taper when moving from left to right across the view illustrated in FIG. 10C. Using the diverging resonant coupler 1010 allows the photodetector 400 to pull the mode over and reduce the Q factor of the resonance in the coupling. It also allows one to manufacture a polarization sensitive photodetector by adjusting a beat length in the coupling, such that the beat length is different for the two different polarization states. Additionally, it should be noted that the width 1030 of the resonant coupler 1010 may converge, or remained unchanged, and still stay within the bounds of the present invention.

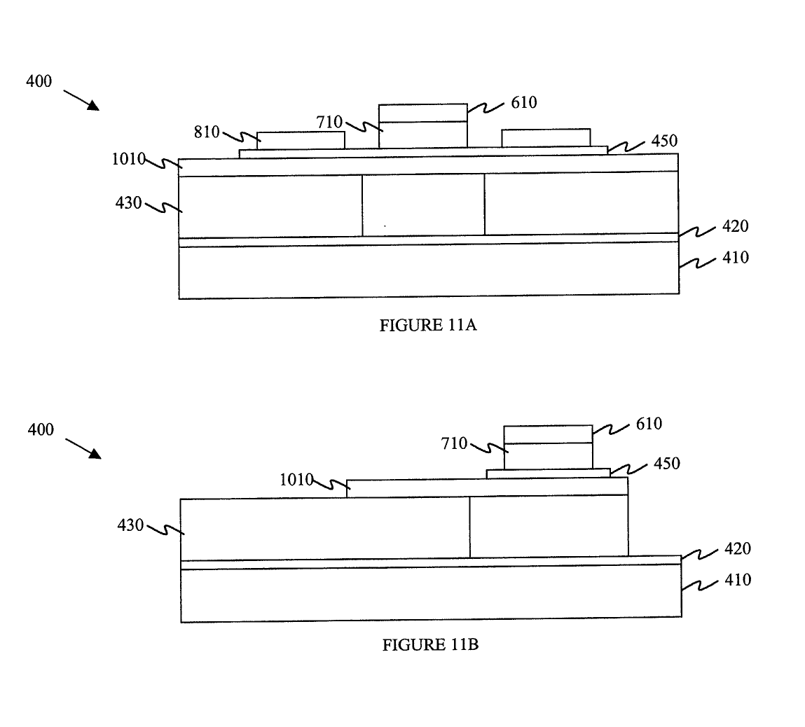

Turning briefly to FIGS. 11A and 11B, illustrated is the partially completed photodetector 400 illustrated in FIGS. 10A, 10B and 10C, after an etching process. In the illustrative embodiment shown in FIGS. 11A and 11B, the partially completed photodetector 400 has been subjected to a ridge etch and a trench etch. The ridge etch may be accomplished using a traditional wet or dry etch, and provides a lateral index step for the waveguide 420. Likewise, the trench etch may be accomplished using a wet etch, and removes conductive material (typically n type material) from under the second photodetector contacts 810. This attempts to reduce the parasitic capacitance of the partially completed photodetector 400.

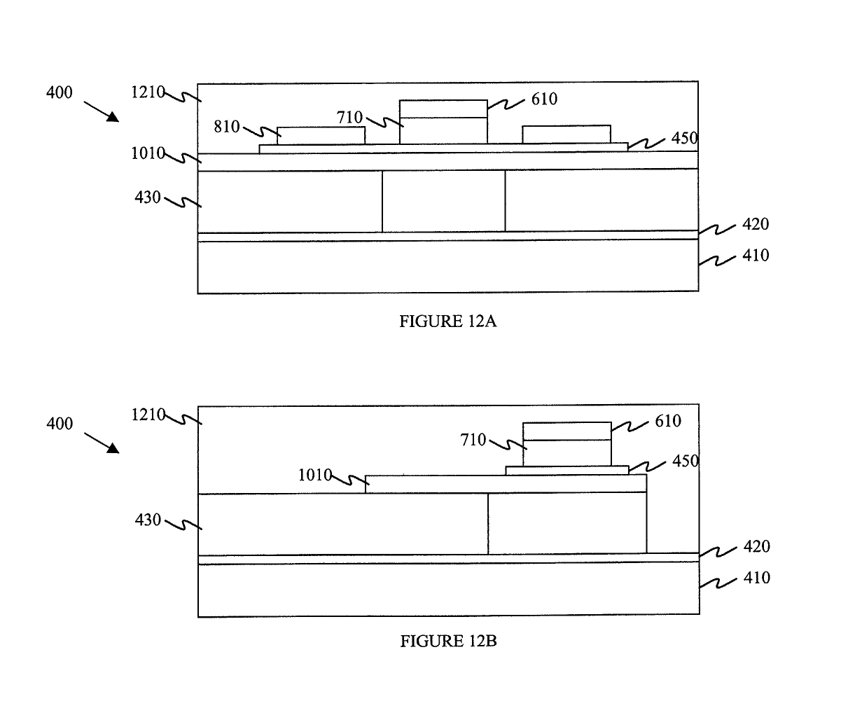

Turning to FIGS. 12A and 12B, illustrated is the partially completed photodetector 400 illustrated in FIGS. 11A and 11B, after formation of a layer of passivation material 1210 thereover. The layer of passivation material 1210, which may be BCB or another similar material, encapsulates the partially completed photodetector 400. It is generally desired that the layer of passivation material 1210 have a dielectric constant of 2.7 or less.

As illustrated in FIGS. 12A and 12B, the layer of passivation material 1210 may be formed to a thickness such that a substantially planar surface results. It is generally desired that the layer of passivation material 1210 have good planarity, e.g., greater than about 90%. Thus, in an exemplary embodiment of the invention, after formation of the passivation material 1210, the passivation material 1210 may be subjected to a planarization process, such as a conventional chemical mechanical planarization (CMP) process. One skilled in the art understands how to form the passivation material 1210, including using a spin-on or other similar process.

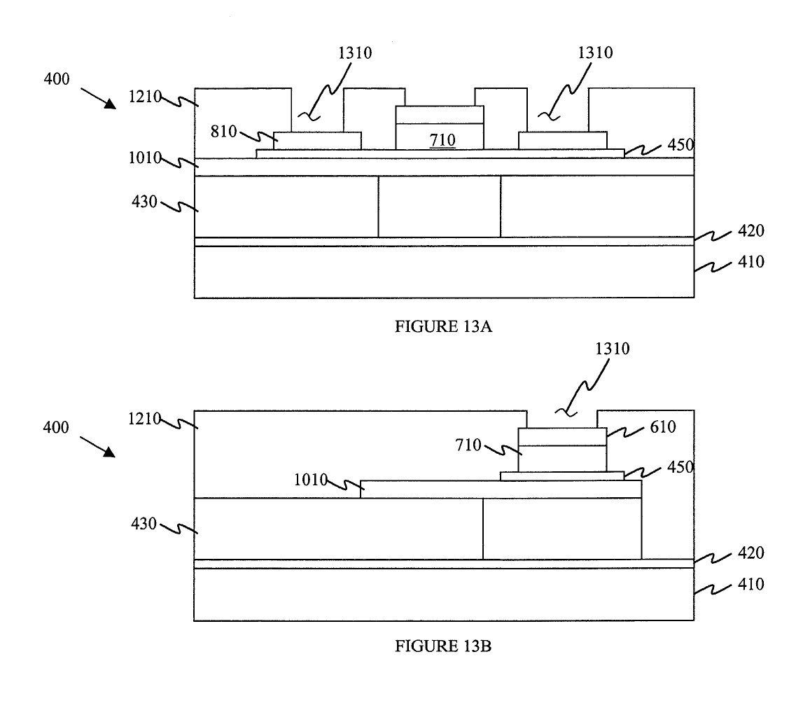

Turning to FIGS. 13A and 13B, illustrated is the partially completed photodetector 400 illustrated in FIGS. 12A and 12B, after formation of contact openings 1310. As illustrated in FIGS. 13A and 13B, the contact openings 1310 may be formed over the first photodetector contact 610 and the second photodetector contacts 810. The contact openings 1310, which may vary in dimension, provide an avenue to provide electrical connection to the first and second photodetector contacts 610, 810. One skilled in the art understands how to form the contact openings 1310 through the layer of passivation material 1200, including using photoresist and a dry etch, therefore, no further discussion is warranted.

Turning to FIGS. 13A and 13B, illustrated is the partially completed photodetector 400 illustrated in FIGS. 13A and 13B, after formation of an interconnect metal layer 1310. The interconnect metal layer 1310, which may comprise any known or hereafter discovered conductive material compatible with the present invention, is formed over the surface of the partially completed photodetector 400 and within the contact openings 1310. The interconnect metal layer 1310 may be formed using many processes, however, in an exemplary embodiment the interconnect metal layer 1310 may be formed using an evaporated metal liftoff process or other similar process. After completion of the interconnect metal layer 1310, the interconnect metal layer 1310 may be conventionally patterned, resulting in a device similar to the completed photodetector 300 illustrated in FIG. 3.

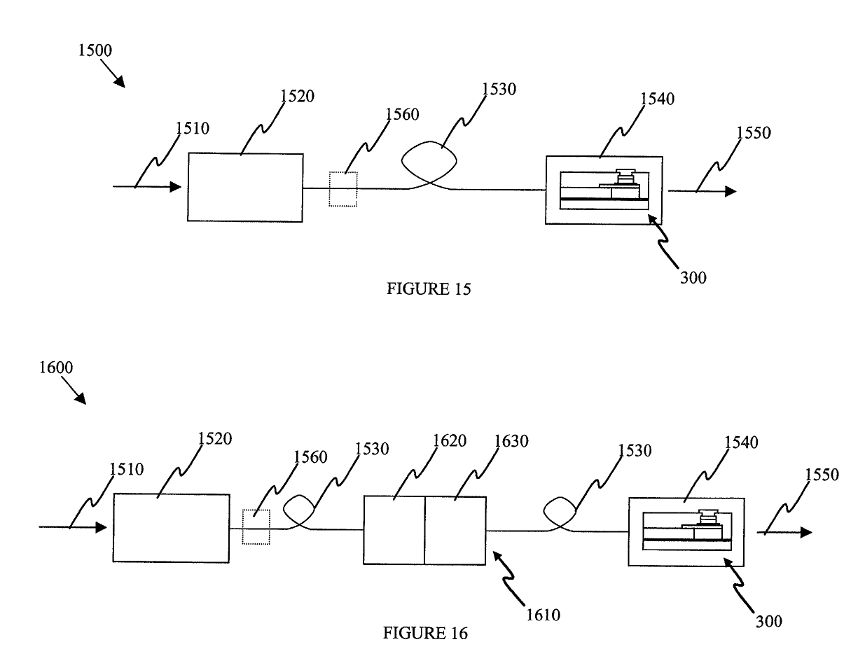

Turning to FIG. 15, illustrated is an optical fiber communication system 1500, which may form one environment in which a completed photodetector similar to the completed photodetector 300 illustrated in FIG. 3, may be used. The optical fiber communication system 1500, in the illustrative embodiment, includes an initial signal 1510 entering a transmitter 1520. The transmitter 1520, receives the initial signal 1510, addresses the signal 1510 and sends any resulting information across an optical fiber 1530 to a receiver 1540. The receiver 1540 receives the information from the optical fiber 1530, addresses the information and sends an ultimate signal 1550. As illustrated in FIG. 15, the completed photodetector 300 may be included within the receiver 1540. However, the completed photodetector 300 may also be included other places within the optical fiber communication system 1500. The optical fiber communication system 1500 is not limited to the devices previously mentioned. For example, the optical fiber communication system 1500 may include an element 1560, such as a laser, diode, modulator, optical amplifier, optical waveguide, or other similar device.

Turning briefly to FIG. 16, illustrated is an alternative optical fiber communication system 1600, having a repeater 1610, including a second transmitter 1620 and a second receiver 1630, located between the transmitter 1520 and the receiver 1540.

Although the present invention has been described in detail, those skilled in the art should understand that they can make various changes, substitutions and alterations herein without departing from the spirit and scope of the invention in its broadest form.

What is claimed is:

1. A photodetector, comprising:
a waveguide located over a photodetector substrate;
a resonant coupler located over and coupled to the waveguide and having an index of refraction greater than an index of refraction of the waveguide; and
an absorber located over and coupled to the resonant coupler and having an index of refraction greater than the index of refraction of the resonant coupler.

2. The photodetector as recited in claim 1 wherein the waveguide is a first waveguide and the resonant coupler is a second waveguide.

3. The photodetector as recited in claim 1 further including a cladding layer located between and in contact with the waveguide and the resonant coupler, the cladding layer having an index of refraction less than the index of refraction of the waveguide.

4. The photodetector as recited in claim 1 wherein the absorber includes an upper doped region and a lower undoped region.

5. The photodetector as recited in claim 1 further including a cladding layer located between and in contact with the resonant coupler and the absorber, the cladding layer having an index of refraction less than the index of refraction of the resonant coupler.

6. The photodetector as recited in claim 1 wherein a far field divergence angle of the waveguide is less than about 15 degrees.

7. The photodetector as recited in claim 1 wherein a propagation constant of the waveguide is substantially the same as a propagation constant of the resonant coupler.

8. The photodetector as recited in claim 1 wherein the waveguide includes undoped indium gallium arsenide phosphide, the resonant coupler includes a doped indium gallium arsenide phosphide, and the absorber includes a doped region of indium gallium arsenide and an undoped region of indium gallium arsenide.

9. A method of manufacturing a photodetector, comprising:
forming a waveguide over a photodetector substrate;
creating a resonant coupler over and the waveguide, the resonant coupler having an index of refraction greater than an index of refraction of the waveguide; and
placing an absorber over the resonant coupler, the absorber having an index of refraction greater than the index of refraction of the resonant coupler.

10. The method as recited in claim 9 wherein forming the waveguide includes forming a first wave guide and creating the resonant coupler includes creating a second waveguide.

11. The method as recited in claim 9 further including depositing a cladding layer on the waveguide prior to creating the resonant coupler and creating the resonant coupler includes depositing the resonant coupler on the cladding layer, the cladding layer having an index of refraction less than the index of refraction of the waveguide.

12. The method as recited in claim 9 wherein forming, creating and placing includes forming a waveguide, creating a resonant coupler and placing an absorber in a single epitaxial deposition process.

13. The method as recited in claim 9 further including forming a cladding layer on the resonant coupler prior to placing the absorber and placing the absorber includes placing the absorber on the cladding layer, the cladding layer having an index of refraction less than the index of refraction of the resonant coupler.

14. The method as recited in claim 9 wherein forming the waveguide includes forming a waveguide having a far field divergence angle that is less than about 15 degrees.

15. The method as recited in claim 9 wherein forming the waveguide and creating the resonant coupler includes forming a waveguide and creating a resonant coupler to have substantially a same propagation constant.

16. The photodetector as recited in claim 1 wherein forming the waveguide includes forming a waveguide with undoped indium gallium arsenide phosphide, creating the resonant coupler includes creating a resonant coupler with a doped indium gallium arsenide phosphide, and placing the absorber includes placing an absorber having a doped region of indium gallium arsenide and an undoped region of indium gallium arsenide.

17. An optical fiber communications system, comprising:
a photodetector, including;
a waveguide located over a photodetector substrate;
a resonant coupler located over and coupled to the waveguide and having an index of refraction greater than an index of refraction of the waveguide; and
an absorber located over and coupled to the resonant coupler and having an index of refraction greater than the index of refraction of the resonant coupler; and
an optical fiber configured to provide a wavelength of light to the photodetector.

18. The optical fiber communications system as recited in claim 17 further including a cladding layer located between and in contact with the waveguide and the resonant coupler, the cladding layer having an index of refraction less than the index of refraction of the waveguide.

19. The optical fiber communications system as recited in claim 17 further including a cladding layer located between and in contact with the resonant coupler and the absorber, the cladding layer having an index of refraction less than the index of refraction of the resonant coupler.

20. The optical fiber communications system as recited in claim 17 further including devices selected from the group consisting of:
lasers,
modulators,
optical amplifiers, and
optical waveguides.
